(19) United States
(12) Patent Application Publication
(10) Pub. No.: US 2025/0328449 A1
(43) Pub. Date: Oct. 23, 2025

(54) Flight Software Testing Using Actual Flight Data

(71) Applicant: Wing Aviation LLC, Palo Alto, CA (US)

(72) Inventors: Anna Verkhovskaya, San Mateo, CA (US); Martin Gustav William Kubie, San Francisco, CA (US)

(21) Appl. No.: 18/643,457

(22) Filed: Apr. 23, 2024

(51) Int. Cl. G06F 11/34; G06F 11/36

(52) U.S. Cl. CPC G06F 11/3457; G06F 11/3684; G06F 11/3692

(57) ABSTRACT

Example embodiments may include determining test flight data based on actual flight data that has been captured by a sensor of an aerial vehicle during a previous flight performed by the aerial vehicle in a physical environment. The test flight data may be processed using a software component that forms part of an aerial vehicle control system. An observed performance of the software component may be determined based on processing the test flight data using the software component. A performance metric may be determined for the software component based on comparing (i) the observed performance of the software component to (ii) an expected performance of the software component. The performance metric may be output.

### BACKGROUND

An uncrewed vehicle, which may also be referred to as an autonomous vehicle, is a vehicle capable of travel without a physically-present human operator. An uncrewed vehicle may operate in a remote-control mode, in an autonomous mode, or in a partially autonomous mode. The term “unmanned” may sometimes be used instead of, or in addition to, “uncrewed,” and it should be understood that both terms have the same meaning, and may be used interchangeably.

When an uncrewed vehicle operates in a remote-control mode, a pilot or driver that is at a remote location can control the uncrewed vehicle via commands that are sent to the uncrewed vehicle via a wireless link. When the uncrewed vehicle operates in autonomous mode, the uncrewed vehicle typically moves based on pre-programmed navigation waypoints, dynamic automation systems, or a combination of these. Further, some uncrewed vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of uncrewed vehicles exist for various different environments. For instance, uncrewed vehicles exist for operation in the air, on the ground, underwater, and in space. Examples include quad-copters and tail-sitter uncrewed aerial vehicles (UAVs), among others. Uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

Software components of an aerial vehicle may be tested using test flight data that is based on actual flight data that has been captured during a previous flights performed by aerial vehicles. Testing may be performed to evaluate updates to the software component, updates to other system components that interact with the software component, compare different version of the software component, and/or otherwise quantify performance of the software component. As a result of being based on the actual flight data, the test flight data may be representative of environmental conditions that the aerial vehicle is likely to encounter during future flights, and may thus be used to accurately gauge aspects of future performance of the aerial vehicle. In some cases, the test flight data may include modifications and/or augmentations of the actual flight data that introduce into the actual flight data representations of simulated environmental conditions that were not present during the previous flights. Such augmentations may be introduced into the actual flight data using, for example, a generative machine learning model. Thus, a given previous flight may be used to generate test flight data that represents how the given previous flight would look to sensors of the aerial vehicle in different weather conditions, at different times of day and/or year, in different air traffic conditions, as a result of some sensor degradations, and/or as a result of other sources of variation.

In a first example embodiment, a method may include determining test flight data based on actual flight data that has been captured by a sensor of an aerial vehicle during a previous flight performed by the aerial vehicle in a physical environment. The method may also include processing the test flight data using a software component that forms part of an aerial vehicle control system, and determining an observed performance of the software component based on processing the test flight data using the software component. The method may additionally include determining a performance metric for the software component based on comparing (i) the observed performance of the software component to (ii) an expected performance of the software component. The method may further include outputting the performance metric.

In a second example embodiment, a system may include a processor and a non-transitory computer-readable medium having stored thereon instructions that, when executed by the processor, cause the processor to perform operations in accordance with the first example embodiment.

In a third example embodiment, a non-transitory computer-readable medium may have stored thereon instructions that, when executed by a computing device, cause the computing device to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1A illustrates an uncrewed aerial vehicle, in accordance with examples described herein.

FIG. 1B illustrates an uncrewed aerial vehicle, in accordance with examples described herein.

FIG. 1C illustrates an uncrewed aerial vehicle, in accordance with examples described herein.

FIG. 1D illustrates an uncrewed aerial vehicle, in accordance with examples described herein.

FIG. 1E illustrates an uncrewed aerial vehicle, in accordance with examples described herein.

FIG. 2 illustrates components of an uncrewed aerial system, in accordance with examples described herein.

FIG. 3 is a block diagram illustrating a distributed UAV system, in accordance with examples described herein.

FIG. 4A illustrates, an example system architecture of an uncrewed aerial vehicle, in accordance with examples described herein.

FIG. 4B illustrates, another example system architecture of an uncrewed aerial vehicle, in accordance with examples described herein.

FIG. 5 illustrates, an example system architecture of test system for an uncrewed aerial vehicle, in accordance with examples described herein.

FIG. 6 is a flow chart of an example method, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

An aerial vehicle (e.g., a UAV) may take various forms and have various components configured to work together to operate the aerial vehicle according to various specifications and requirements, and under a variety of operational circumstances and situations. Aerial vehicle components may include flight control devices (e.g., motors, rotors, flaps, ailerons, etc.) and flight software components that may be configured to form and/or operate as part of an aerial vehicle control system configured to control the flight control devices, among other functions. Aerial vehicle components may also include one or more sensors for detecting, measuring, and/or observing physical and/or environmental circumstances and/or conditions under which the aerial vehicle operates. Sensor data generated by the one or more sensors may then be used by the aerial vehicle control system in the course of aerial vehicle operations.

Examples of operating conditions may include weather (e.g., illustrating effects of rain, snow, wind, sun, etc.), geographic location in which the aerial vehicle operates (e.g., illustrating variations in availability of satellite-based navigation systems, availability of visual features for vision-based navigation systems, etc.), air traffic in the vicinity of the aerial vehicle (e.g., illustrating varying tolerances in adherence to a specified aerial path, etc.).

During development of aerial vehicle flight software and/or when software components of the flight software are revised, updated, and/or newly added, a testing environment may be used to test individual software components and/or the integrated system as a whole for expected and/or unexpected behavior and/or interactions. An example testing environment, also referred to herein as a “UAV test bed,” may include a computing system that implements flight software of the aerial vehicle, as well as real and/or simulated sensors and flight control devices. The testing environment may also include one or more interfaces for inputting sensor data, and for monitoring control signals from the aerial vehicle control system to flight control devices. Performance of the software components and/or the entire system may then be monitored during testing for verification, validation, performance measurement, and/or troubleshooting purposes.

One of the challenges of testing aerial vehicle flight software is producing the effects of physical environmental circumstances/conditions in a testing context. In some cases, some environments and/or various conditions therein (e.g., weather and/or visibility) may be simulated using virtual environments, and synthetic sensor data may be generated based on these simulations. However, verification of existing flight software might not be entirely reliable when tested against synthetic sensor data. For example, the synthetic sensor data might not accurately represent how actual environmental conditions will be represented in actual sensor data. Thus, actual flight data recorded by aerial vehicles during actual flights may be used as input to the sensors of an aerial vehicle test bed in order to reproduce the actual effects of operating conditions for testing aerial vehicle flight software. In some cases, the actual flight data may be augmented based on simulated environmental conditions. Doing so may enhance the reliability of test results, since the behavior of existing aerial vehicle flight software executed in the testing context (e.g., on a UAV test bed) can be verified against the actual aerial vehicle behavior during the flights as represented in actual flight data.

Accordingly, example embodiments described herein provide systems and methods for using actual aerial vehicle flight data, recorded by one or more aerial vehicles during actual flights, as inputs to a UAV test bed or other aerial vehicle testing context or environment. In particular, flight data corresponding to operating conditions experienced during previous flights may serve as inputs to one or more sensors of a UAV test bed. In some examples, the source of the flight data used in testing may be flight logs or other types or forms of recorded data. The flight data may include sensor data and/or control signals provided to different components of the aerial vehicle.

In some embodiments, the actual flight data may be preprocessed before being input to the UAV test bed. In some examples, the actual flight data may be processed into a form suitable for direct input to a sensor, and the sensor may be provided with the processed flight data as input. In some other, the actual flight data may be processed into a form that represents a sensor output (e.g., of UAV test bed sensors), and the actual flight data as processed may be input to an aerial vehicle control system of the UAV test bed.

In some embodiments, flight data preprocessing may be used to modify, distort, and/or perturb the representation of the actual environmental conditions under which the actual flight data was acquired. In this way, aerial vehicle flight software may be tested against realistic environmental conditions that include synthetic modification that may represent errors, noise, degradations, and/or other variations that the aerial vehicle is expected to be robust to. For example, visual flight data obtained from a UAV vision system may be modified to degrade the actual visibility that was present when the data were acquired. Testing with distorted visual data may then allow for the effects of such distortions on computer vision software to be studied and/or evaluated. Effects on system behavior may also be evaluated. In some examples, a machine learning (ML) model may be used to generate, determine, and/or add one or more modifications and/or distortions of environmental conditions recorded and/or represented in the actual flight data.

Some of the example embodiments herein are described in terms of testing of a computer vision software of a computer vision system of a UAV, and recorded visual data from one or more actual flights of one or more UAVs. However, the principles described by way of example herein may be extended to other components and/or modules of a UAV. Similarly, the principles may be extended to other types of autonomous vehicles, besides aerial vehicles (e.g., ground vehicles, water vehicles, etc.).

### II. Example Uncrewed Vehicles

Herein, the terms “unmanned aerial system,” “uncrewed aerial system,” and/or “UAV” refer to any autonomous or semi-autonomous vehicle that is capable of performing some functions without a physically present human pilot. A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), “unmanned aerial vehicle,” or “uncrewed aerial vehicle” may also be used to refer to a UAV.

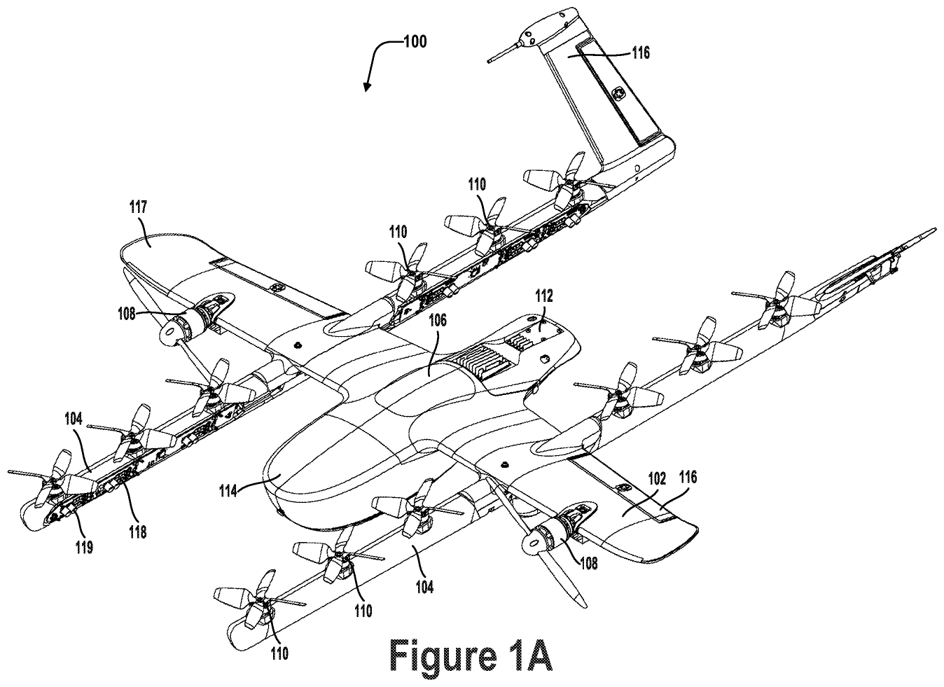

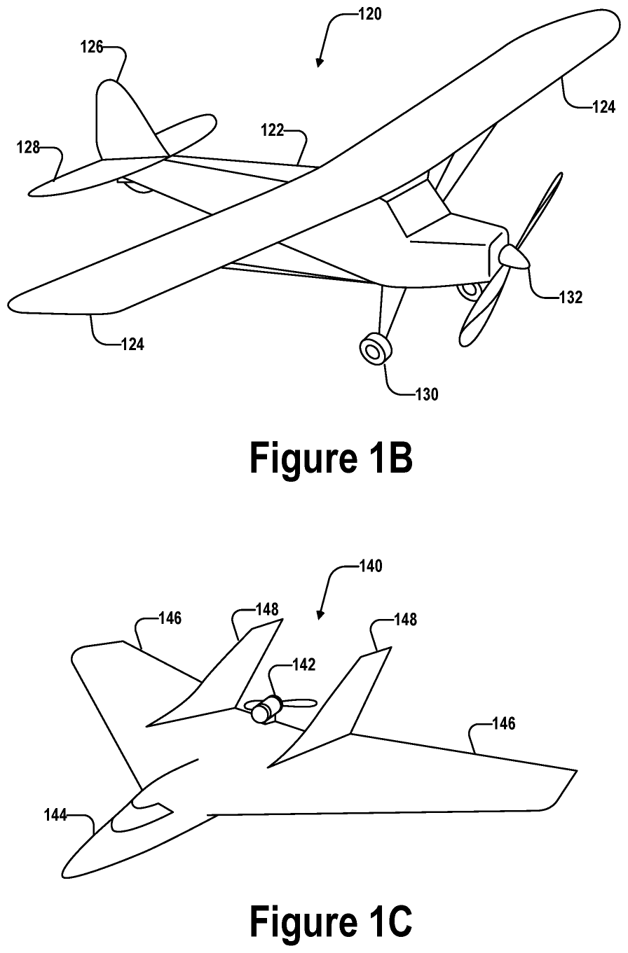

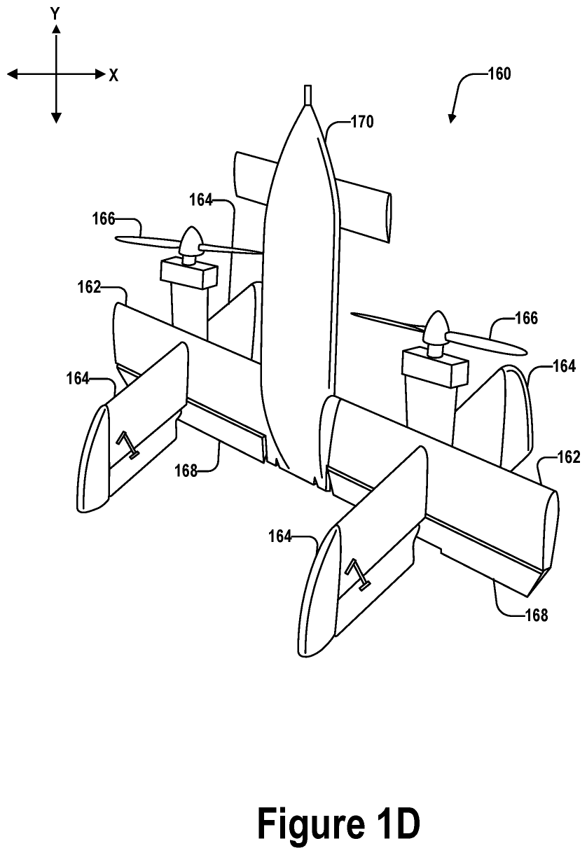

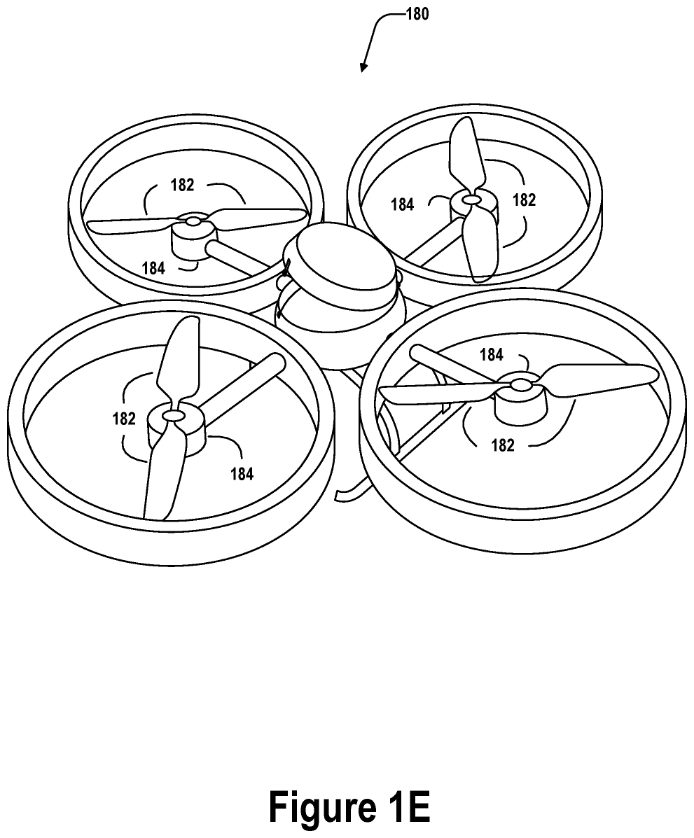

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. Fixed-wing UAV 120 includes fuselage 122, two wings 124 with an airfoil-shaped cross section to provide lift for UAV 120, vertical stabilizer 126 (or fin) to stabilize the plane's yaw (turn left or right), horizontal stabilizer 128 (also referred to as an elevator or tailplane) to stabilize pitch (tilt up or down), landing gear 130, and propulsion unit 132, which can include a motor, shaft, and propeller.

FIG. 1C shows an example of UAV 140 with a propeller in a pusher configuration. The term “pusher” refers to the fact that propulsion unit 142 is mounted at the back of UAV 140 and “pushes” the vehicle forward, in contrast to the propulsion unit 142 being mounted at the front of UAV 140. Similar to the description provided for FIGS. 1A and 1B, FIG. 1C depicts common structures used in a pusher plane, including fuselage 144, two wings 146, vertical stabilizers 148, and propulsion unit 142, which can include a motor, shaft, and propeller.

FIG. 1D shows an example tail-sitter UAV 160. In the illustrated example, tail-sitter UAV 160 has fixed wings 162 to provide lift and allow UAV 160 to glide horizontally (e.g., along the x-axis, in a position that is approximately perpendicular to the position shown in FIG. 1D). However, fixed wings 162 also allow tail-sitter UAV 160 to take off and land vertically on its own.

For example, at a launch site, tail-sitter UAV 160 may be positioned vertically (as shown) with fins 164 and/or wings 162 resting on the ground and stabilizing UAV 160 in the vertical position. Tail-sitter UAV 160 may then take off by operating propellers 166 to generate an upward thrust (e.g., a thrust that is generally along the y-axis). Once at a suitable altitude, tail-sitter UAV 160 may use flaps 168 to reorient itself in a horizontal position, such that fuselage 170 is closer to being aligned with the x-axis than the y-axis. Positioned horizontally, propellers 166 may provide forward thrust so that tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of rotorcraft 180 that is commonly referred to as a multicopter. Multicopter 180 may also be referred to as a quadcopter, as it includes four rotors 182. It should be understood that example embodiments may involve a rotorcraft with more or fewer rotors than multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to multicopter 180 in greater detail, four rotors 182 provide propulsion and maneuverability for multicopter 180. More specifically, each rotor 182 includes blades that are attached to motor 184. Configured as such, rotors 182 may allow multicopter 180 to take off and land vertically, to maneuver in any direction, and/or to hover. Further, the pitch of the blades may be adjusted as a group and/or differentially, and may allow multicopter 180 to control its pitch, roll, yaw, and/or altitude.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Example UAV Components

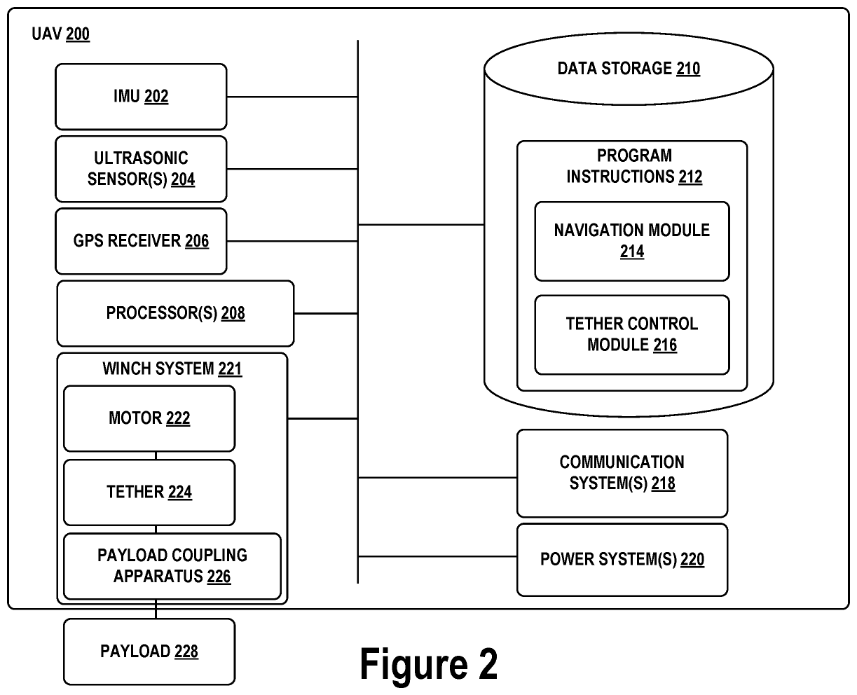

FIG. 2 is a simplified block diagram illustrating components of UAV 200, according to an example embodiment. UAV 200 may take the form of, or be similar in form to, one of UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include inertial measurement unit (IMU) 202, ultrasonic sensor(s) 204, and GPS receiver 206, among other possible sensors and sensing systems.

In the illustrated embodiment, UAV 200 also includes processor(s) 208. Processor 208 may be a general-purpose processor or a special purpose processor (e.g., digital signal processors, application specific integrated circuits, etc.). Processor(s) 208 can be configured to execute computer-readable program instructions 212 that are stored in data storage 210 and are executable to provide the functionality of a UAV described herein.

Data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of processor(s) 208. In some embodiments, data storage 210 can be implemented using a single physical device (e.g., one optical, magnetic, organic or other memory or disc storage unit), while in other embodiments, data storage 210 can be implemented using two or more physical devices.

As noted, data storage 210 can include computer-readable program instructions 212 and perhaps additional data, such as diagnostic data of UAV 200. As such, data storage 210 may include program instructions 212 to perform or facilitate some or all of the UAV functionality described herein. For instance, in the illustrated embodiment, program instructions 212 include navigation module 214 and tether control module 216.

In an illustrative embodiment, IMU 202 may include both an accelerometer and a gyroscope, which may be used together to determine an orientation of UAV 200. In particular, the accelerometer can measure the orientation of the vehicle with respect to earth, while the gyroscope measures the rate of rotation around an axis. IMUs are commercially available in low-cost, low-power packages. For instance, IMU 202 may take the form of or include a miniaturized MicroElectroMechanical System (MEMS) or a NanoElectroMechanical System (NEMS). Other types of IMUs may also be utilized.

IMU 202 may include other sensors, in addition to accelerometers and gyroscopes, which may help to better determine position and/or help to increase autonomy of UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e,g., by applying optical flow techniques to images), video feedback, and/or image recognition and processing, among other possibilities.

UAV 200 may also include GPS receiver 206. GPS receiver 206 may be configured to provide data that is typical of well-known GPS systems, such as the GPS coordinates of UAV 200. Such GPS data may be utilized by UAV 200 for various functions. As such, the UAV may use GPS receiver 206 to help navigate to the caller's location, as indicated, at least in part, by the GPS coordinates provided by their mobile device. Other examples are also possible.

Navigation module 214 may provide functionality that allows UAV 200 to, for example, move about its environment and reach a desired location. To do so, navigation module 214 may control the altitude and/or direction of flight by controlling the mechanical features of the UAV that affect flight (e.g., its rudder(s), elevator(s), aileron(s), and/or the speed of its propeller(s)).

In order to navigate UAV 200 to a target location, navigation module 214 may implement various navigation techniques, such as map-based navigation and localization-based navigation, for instance. With map-based navigation, UAV 200 may be provided with a map of its environment, which may then be used to navigate to a particular location on the map. With localization-based navigation, UAV 200 may be capable of navigating in an unknown environment using localization. Localization-based navigation may involve UAV 200 building its own map of its environment and calculating its position within the map and/or the position of objects in the environment. For example, as UAV 200 moves throughout its environment, UAV 200 may continuously use localization to update its map of the environment. This continuous mapping process may be referred to as simultaneous localization and mapping (SLAM). Other navigation techniques may also be utilized.

In some embodiments, navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, navigation module 214 and/or other components and systems of UAV 200 may be configured for “localization” to more precisely navigate to the scene of a target location. More specifically, it may be desirable in certain situations for a UAV to be within a threshold distance of the target location where payload 228 is being delivered by a UAV (e.g., within a few feet of the target destination). To this end, a UAV may use a two-tiered approach in which it uses a more—general location-determination technique to navigate to a general area that is associated with the target location, and then use a more-refined location-determination technique to identify and/or navigate to the target location within the general area.

For example, UAV 200 may navigate to the general area of a target destination where payload 228 is being delivered using waypoints and/or map-based navigation. The UAV may then switch to a mode in which it utilizes a localization process to locate and travel to a more specific location. For instance, if UAV 200 is to deliver a payload to a user's home, UAV 200 may need to be substantially close to the target location in order to avoid delivery of the payload to undesired areas (e.g., onto a roof, into a pool, onto a neighbor's property, etc.). However, a GPS signal may only get UAV 200 so far (e.g., within a block of the user's home). A more precise location-determination technique may then be used to find the specific target location.

Various types of location-determination techniques may be used to accomplish localization of the target delivery location once UAV 200 has navigated to the general area of the target delivery location. For instance, UAV 200 may be equipped with one or more sensory systems, such as, for example, ultrasonic sensors 204, infrared sensors (not shown), and/or other sensors, which may provide input that navigation module 214 utilizes to navigate autonomously or semi-autonomously to the specific target location.

As another example, once UAV 200 reaches the general area of the target delivery location (or of a moving subject such as a person or their mobile device), UAV 200 may switch to a “fly-by-wire” mode where it is controlled, at least in part, by a remote operator, who can navigate UAV 200 to the specific target location. To this end, sensory data from UAV 200 may be sent to the remote operator to assist them in navigating UAV 200 to the specific location.

As yet another example, UAV 200 may include a module that is able to signal to a passer-by for assistance in reaching the specific target delivery location. For example, the UAV 200 may display a visual message requesting such assistance in a graphic display or play an audio message or tone through speakers to indicate the need for such assistance, among other possibilities. Such a visual or audio message might indicate that assistance is needed in delivering UAV 200 to a particular person or a particular location, and might provide information to assist the passer-by in delivering UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once UAV 200 arrives at the general area of a target delivery location, UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, UAV 200 may be configured to navigate by “sourcing” such directional signals—in other words, by determining where the signal is strongest and navigating accordingly. As another example, a mobile device can emit a frequency, either in the human range or outside the human range, and UAV 200 can listen for that frequency and navigate accordingly. As a related example, if UAV 200 is listening for spoken commands, then UAV 200 could utilize spoken statements, such as “I'm over here!” to source the specific location of the person requesting delivery of a payload.

In an alternative arrangement, a navigation module may be implemented at a remote computing device, which communicates wirelessly with UAV 200. The remote computing device may receive data indicating the operational state of UAV 200, sensor data from UAV 200 that allows it to assess the environmental conditions being experienced by UAV 200, and/or location information for UAV 200. Provided with such information, the remote computing device may determine altitudinal and/or directional adjustments that should be made by UAV 200 and/or may determine how UAV 200 should adjust its mechanical features (e.g., its rudder(s), elevator(s), aileron(s), and/or the speed of its propeller(s)) in order to effectuate such movements. The remote computing system may then communicate such adjustments to UAV 200 so it can move in the determined manner.

In a further aspect, UAV 200 includes one or more communication system(s) 218. Communications system(s) 218 may include one or more wireless interfaces and/or one or more wireline interfaces, which allow UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, UAV 200 may include communication systems 218 that allow for both short-range communication and long-range communication. For example, UAV 200 may be configured for short-range communications using Bluetooth and for long-range communications under a CDMA protocol. In such an embodiment, UAV 200 may be configured to function as a “hot spot;” or in other words, as a gateway or proxy between a remote support device and one or more data networks, such as a cellular network and/or the Internet. Configured as such, UAV 200 may facilitate data communications that the remote support device would otherwise be unable to perform by itself.

For example, UAV 200 may provide a WiFi connection to a remote device, and serve as a proxy or gateway to a cellular service provider's data network, which the UAV might connect to under an LTE or a 3G protocol, for instance. UAV 200 could also serve as a proxy or gateway to a high-altitude balloon network, a satellite network, or a combination of these networks, among others, which a remote device might not be able to otherwise access.

In a further aspect, UAV 200 may include power system(s) 220. Power system(s) 220 may include one or more batteries for providing power to UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

UAV 200 may employ various systems and configurations in order to transport and deliver payload 228. In some implementations, payload 228 of UAV 200 may include or take the form of a “package” designed to transport various goods to a target delivery location. For example, UAV 200 can include a compartment, in which an item or items may be transported. Such a package may one or more food items, purchased goods, medical items, or any other object(s) having a size and weight suitable to be transported between two locations by the UAV. In other embodiments, payload 228 may simply be the one or more items that are being delivered (e.g., without any package housing the items).

In some embodiments, payload 228 may be attached to the UAV and located substantially outside of the UAV during some or all of a flight by the UAV. For example, the package may be tethered or otherwise releasably attached below the UAV during flight to a target location. In an embodiment where a package carries goods below the UAV, the package may include various features that protect its contents from the environment, reduce aerodynamic drag on the system, and prevent the contents of the package from shifting during UAV flight.

In order to deliver the payload, the UAV may include winch system 221 controlled by tether control module 216 in order to lower payload 228 to the ground while UAV 200 hovers above. As shown in FIG. 2, winch system 221 may include tether 224, and tether 224 may be coupled to payload 228 by payload coupling apparatus 226. Tether 224 may be wound on a spool that is coupled to motor 222 of the UAV. Motor 222 may take the form of a DC motor (e.g., a servo motor) that can be actively controlled by a speed controller. Tether control module 216 can control the speed controller to cause motor 222 to rotate the spool, thereby unwinding or retracting tether 224 and lowering or raising payload coupling apparatus 226. In practice, the speed controller may output a desired operating rate (e.g., a desired RPM) for the spool, which may correspond to the speed at which tether 224 and payload 228 should be lowered towards the ground. Motor 222 may then rotate the spool so that it maintains the desired operating rate.

In order to control motor 222 via the speed controller, tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as motor 222 causes rotation of the spool, a rotary encoder may be used to measure this rotation. In doing so, the rotary encoder may be used to convert a rotary position to an analog or digital electronic signal used by tether control module 216 to determine the amount of rotation of the spool from a fixed reference angle and/or to an analog or digital electronic signal that is representative of a new rotary position, among other options. Other examples are also possible.

Based on the data from the speed sensor, tether control module 216 may determine a rotational speed of motor 222 and/or the spool and responsively control motor 222 (e.g., by increasing or decreasing an electrical current supplied to motor 222) to cause the rotational speed of motor 222 to match a desired speed. When adjusting the motor current, the magnitude of the current adjustment may be based on a proportional-integral-derivative (PID) calculation using the determined and desired speeds of motor 222. For instance, the magnitude of the current adjustment may be based on a present difference, a past difference (based on accumulated error over time), and a future difference (based on current rates of change) between the determined and desired speeds of the spool.

In some embodiments, tether control module 216 may vary the rate at which tether 224 and payload 228 are lowered to the ground. For example, the speed controller may change the desired operating rate according to a variable deployment-rate profile and/or in response to other factors in order to change the rate at which payload 228 descends toward the ground. To do so, tether control module 216 may adjust an amount of braking or an amount of friction that is applied to tether 224. For example, to vary the tether deployment rate, UAV 200 may include friction pads that can apply a variable amount of pressure to tether 224. As another example, UAV 200 can include a motorized braking system that varies the rate at which the spool lets out tether 224. Such a braking system may take the form of an electromechanical system in which motor 222 operates to slow the rate at which the spool lets out tether 224. Further, motor 222 may vary the amount by which it adjusts the speed (e.g., the RPM) of the spool, and thus may vary the deployment rate of tether 224. Other examples are also possible.

In some embodiments, tether control module 216 may be configured to limit the motor current supplied to motor 222 to a maximum value. With such a limit placed on the motor current, there may be situations where motor 222 cannot operate at the desired rate specified by the speed controller. For instance, there may be situations where the speed controller specifies a desired operating rate at which motor 222 should retract tether 224 toward UAV 200, but the motor current may be limited such that a large enough downward force on tether 224 would counteract the retracting force of motor 222 and cause tether 224 to unwind instead. A limit on the motor current may be imposed and/or altered depending on an operational state of UAV 200.

In some embodiments, tether control module 216 may be configured to determine a status of tether 224 and/or payload 228 based on the amount of current supplied to motor 222. For instance, if a downward force is applied to tether 224 (e.g., if payload 228 is attached to tether 224 or if tether 224 gets snagged on an object when retracting toward UAV 200), tether control module 216 may need to increase the motor current in order to cause the determined rotational speed of motor 222 and/or spool to match the desired speed. Similarly, when the downward force is removed from tether 224 (e.g., upon delivery of payload 228 or removal of a tether snag), tether control module 216 may need to decrease the motor current in order to cause the determined rotational speed of motor 222 and/or spool to match the desired speed. As such, tether control module 216 may be configured to monitor the current supplied to motor 222. For instance, tether control module 216 could determine the motor current based on sensor data received from a current sensor of the motor or a current sensor of power system 220. In any case, based on the current supplied to motor 222, tether control module 216 may determine if payload 228 is attached to tether 224, if someone or something is pulling on tether 224, and/or if payload coupling apparatus 226 is pressing against UAV 200 after retracting tether 224. Other examples are possible as well.

During delivery of payload 228, payload coupling apparatus 226 can be configured to secure payload 228 while being lowered from the UAV by tether 224, and can be further configured to release payload 228 upon reaching ground level. Payload coupling apparatus 226 can then be retracted to the UAV by reeling in tether 224 using motor 222.

In some implementations, payload 228 may be passively released once it is lowered to the ground. For example, a passive release mechanism may include one or more swing arms adapted to retract into and extend from a housing. An extended swing arm may form a hook on which payload 228 may be attached. Upon lowering the release mechanism and payload 228 to the ground via a tether, a gravitational force as well as a downward inertial force on the release mechanism may cause payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of payload 228 no longer forces the swing arm to extend from the housing. Retracting the swing arm into the housing may reduce the likelihood of the release mechanism snagging payload 228 or other nearby objects when raising the release mechanism toward the UAV upon delivery of payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, UAV 200 could include an air-bag drop system or a parachute drop system. Alternatively, UAV 200 carrying a payload could simply land on the ground at a delivery location. Other examples are also possible.

### IV. Example UAV Deployment Systems

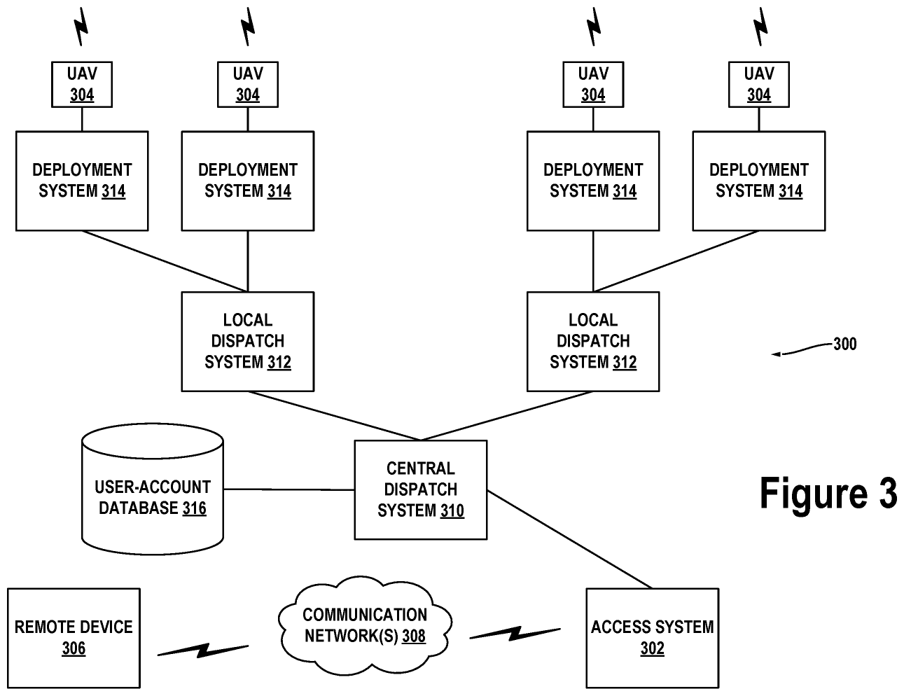

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, access system 302 may allow for interaction with, control of, and/or utilization of a network of UAVs 304. In some embodiments, access system 302 may be a computing system that allows for human-controlled dispatch of UAVs 304. As such, the control system may include or otherwise provide a user interface through which a user can access and/or control UAVs 304.

In some embodiments, dispatch of UAVs 304 may additionally or alternatively be accomplished via one or more automated processes. For instance, access system 302 may dispatch one of UAVs 304 to transport a payload to a target location, and the UAV may autonomously navigate to the target location by utilizing various on-board sensors, such as a GPS receiver and/or other various navigational sensors.

Further, access system 302 may provide for remote operation of a UAV. For instance, access system 302 may allow an operator to control the flight of a UAV via its user interface. As a specific example, an operator may use access system 302 to dispatch one of UAVs 304 to a target location. The dispatched UAV may then autonomously navigate to the general area of the target location. At this point, the operator may use access system 302 to take control of the dispatched UAV and navigate the dispatched UAV to the target location (e.g., to a particular person to whom a payload is being transported). Other examples of remote operation of a UAV are also possible.

In an illustrative embodiment, UAVs 304 may take various forms. For example, each of UAVs 304 may be a UAV such as those illustrated in FIG. 1A, 1B, 1C, 1D, 1E, or 2. However, UAV system 300 may also utilize other types of UAVs without departing from the scope of the invention. In some implementations, all of UAVs 304 may be of the same or a similar configuration. However, in other implementations, UAVs 304 may include a number of different types of UAVs. For instance, UAVs 304 may include a number of types of UAVs, with each type of UAV being configured for a different type or types of payload delivery capabilities.

UAV system 300 may further include remote device 306, which may take various forms. Generally, remote device 306 may be any device through which a direct or indirect request to dispatch a UAV can be made. Note that an indirect request may involve any communication that may be responded to by dispatching a UAV, such as requesting a package delivery. In an example embodiment, remote device 306 may be a mobile phone, tablet computer, laptop computer, personal computer, or any network-connected computing device. Further, in some instances, remote device 306 may not be a computing device. As an example, a standard telephone, which allows for communication via plain old telephone service (POTS), may serve as remote device 306. Other types of remote devices are also possible.

Further, remote device 306 may be configured to communicate with access system 302 via one or more types of communication network(s) 308. For example, remote device 306 may communicate with access system 302 (or a human operator of access system 302) by communicating over a POTS network, a cellular network, and/or a data network such as the Internet. Other types of networks may also be utilized.

In some embodiments, remote device 306 may be configured to allow a user to request pick-up of one or more items from a certain source location and/or delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, UAV system 300 may receive location information (e.g., GPS coordinates, etc.) from the user's mobile phone, or any other device on the user's person, such that a UAV can navigate to the user's location (as indicated by their mobile phone).

In an illustrative arrangement, central dispatch system 310 may be a server or group of servers, which is configured to receive dispatch messages requests and/or dispatch instructions from access system 302. Such dispatch messages may request or instruct central dispatch system 310 to coordinate the deployment of UAVs to various target locations. Central dispatch system 310 may be further configured to route such requests or instructions to one or more local dispatch systems 312. To provide such functionality, central dispatch system 310 may communicate with access system 302 via a data network, such as the Internet or a private network that is established for communications between access systems and automated dispatch systems.

In the illustrated configuration, central dispatch system 310 may be configured to coordinate the dispatch of UAVs 304 from a number of different local dispatch systems 312. As such, central dispatch system 310 may keep track of which ones of UAVs 304 are located at which ones of local dispatch systems 312, which UAVs 304 are currently available for deployment, and/or which services or operations each of UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when central dispatch system 310 receives a request for UAV-related service (e.g., transport of an item) from access system 302, central dispatch system 310 may select a specific one of UAVs 304 to dispatch. Central dispatch system 310 may accordingly instruct local dispatch system 312 that is associated with the selected UAV to dispatch the selected UAV. Local dispatch system 312 may then operate its associated deployment system 314 to launch the selected UAV. In other cases, central dispatch system 310 may forward a request for a UAV-related service to one of local dispatch systems 312 that is near the location where the support is requested and leave the selection of a particular one of UAVs 304 to local dispatch system 312.

In an example configuration, local dispatch system 312 may be implemented as a computing system at the same location as deployment system(s) 314 that it controls. For example, a particular one of local dispatch system 312 may be implemented by a computing system installed at a building, such as a warehouse, where deployment system(s) 314 and UAV(s) 304 that are associated with the particular one of local dispatch systems 312 are also located. In other embodiments, the particular one of local dispatch systems 312 may be implemented at a location that is remote to its associated deployment system(s) 314 and UAV(s) 304.

Numerous variations on and alternatives to the illustrated configuration of UAV system 300 are possible. For example, in some embodiments, a user of remote device 306 could request delivery of a package directly from central dispatch system 310. To do so, an application may be implemented on remote device 306 that allows the user to provide information regarding a requested delivery, and generate and send a data message to request that UAV system 300 provide the delivery. In such an embodiment, central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to central dispatch system 310, local dispatch system(s) 312, access system 302, and/or deployment system(s) 314 may be combined in a single system, implemented in a more complex system (e.g., having more layers of control), and/or redistributed among central dispatch system 310, local dispatch system(s) 312, access system 302, and/or deployment system(s) 314 in various ways.

Yet further, while each local dispatch system 312 is shown as having two associated deployment systems 314, a given local dispatch system 312 may alternatively have more or fewer associated deployment systems 314. Similarly, while central dispatch system 310 is shown as being in communication with two local dispatch systems 312, central dispatch system 310 may alternatively be in communication with more or fewer local dispatch systems 312.

In a further aspect, deployment systems 314 may take various forms. In some implementations, some or all of deployment systems 314 may be a structure or system that passively facilitates a UAV taking off from a resting position to begin a flight. For example, some or all of deployment systems 314 may take the form of a landing pad, a hangar, and/or a runway, among other possibilities. As such, a given deployment system 314 may be arranged to facilitate deployment of one UAV 304 at a time, or deployment of multiple UAVs (e.g., a landing pad large enough to be utilized by multiple UAVs concurrently).

Additionally or alternatively, some or all of deployment systems 314 may take the form of or include systems for actively launching one or more of UAVs 304. Such launch systems may include features that provide for an automated UAV launch and/or features that allow for a human-assisted UAV launch. Further, a given deployment system 314 may be configured to launch one particular UAV 304, or to launch multiple UAVs 304.

Note that deployment systems 314 may also be configured to passively facilitate and/or actively assist a UAV when landing. For example, the same landing pad could be used for take-off and landing. Deployment system 314 could also include other structures and/or systems to assist and/or facilitate UAV landing processes.

Deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, local dispatch systems 312 (along with their respective deployment system(s) 314 may be strategically distributed throughout an area such as a city. For example, local dispatch systems 312 may be strategically distributed such that each local dispatch systems 312 is proximate to one or more payload pickup locations (e.g., near a restaurant, store, or warehouse). However, local dispatch systems 312 may be distributed in other ways, depending upon the particular implementation.

As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, UAV system 300 may include or have access to user-account database 316. User-account database 316 may include data for a number of user accounts, and which are each associated with one or more person. For a given user account, user-account database 316 may include data related to or useful in providing UAV-related services. Typically, the user data associated with each user account is optionally provided by an associated user and/or is collected with the associated user's permission.

Further, in some embodiments, a person may be required to register for a user account with UAV system 300, if they wish to be provided with UAV-related services by UAVs 304 from UAV system 300. As such, user-account database 316 may include authorization information for a given user account (e.g., a user name and password), and/or other information that may be used to authorize access to a user account.

In some embodiments, a person may associate one or more of their devices with their user account, such that they can access the services of UAV system 300. For example, when a person uses an associated mobile phone to, e.g., place a call to an operator of access system 302 or send a message requesting a UAV-related service to a dispatch system, the phone may be identified via a unique device identification number, and the call or message may then be attributed to the associated user account. Other examples are also possible.

### V. Example Flight Software Testing Environment Using Actual Flight Data

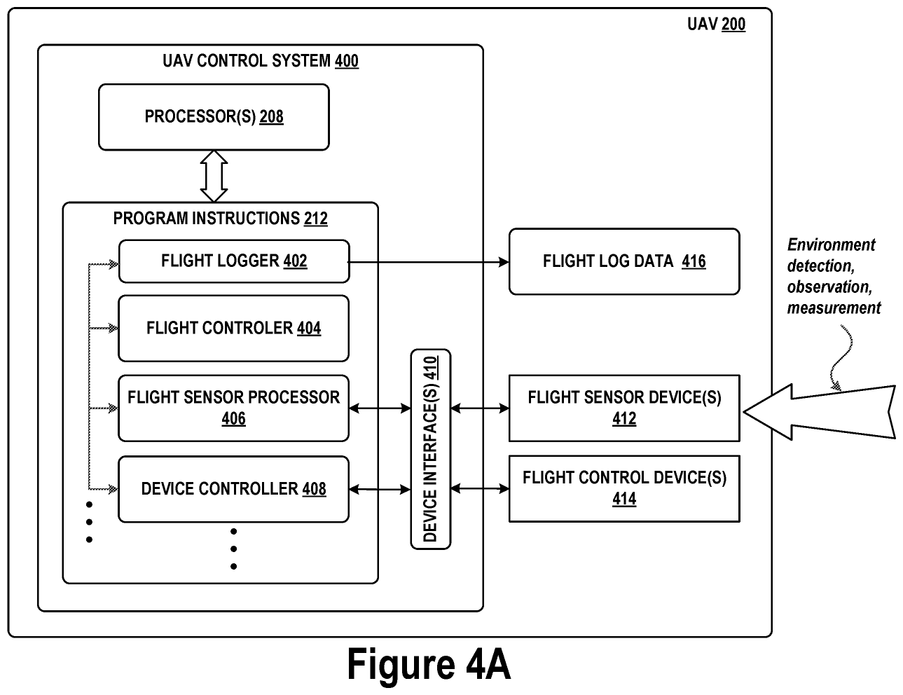

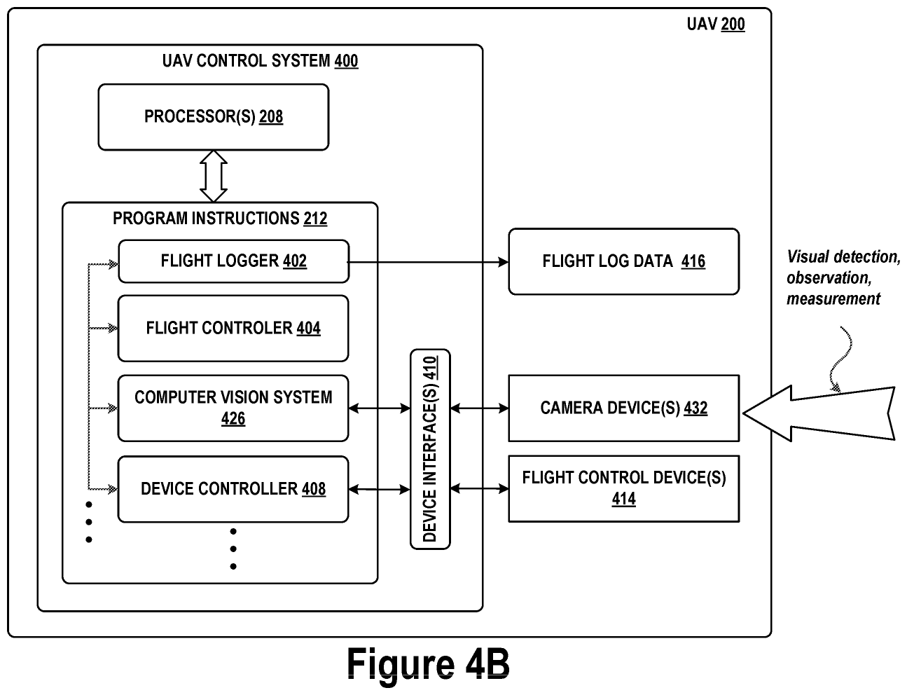

The simplified block diagram of UAV 200 illustrated in FIG. 2 depicts various components of an example UAV. FIG. 4A shows an alternative view of UAV 200 in terms of a high-level architecture of example software modules and their relationships to certain hardware components of UAV 200. In particular, the processor 208 and program instructions 212 shown in FIG. 2 are viewed together architecturally in FIG. 4A as parts of a UAV control system 400. In the example shown, UAV control system 400 also includes device interfaces 410 for interfacing with various hardware components of UAV 200.

In the architectural view, program instructions 212 are organized according to modules, including flight logger 402, flight controller 404, flight sensor processor 406, and device controller 408. Each of flight logger 402, flight controller 404, flight sensor processor 406, and/or device controller 408 may be organized and/or formed using one or more modules and/or components. Arrows between the modules represent communicative connections. Vertical ellipses indicate additional possible modules and connections. The particular modules shown and their functions, as described below, serve as one possible example arrangement that is convenient for the purposes of describing embodiments of testing flight software using actual flight data. It should be understood that a UAV architecture may be configured and/or described using different and/or additional modules than the ones shown in FIG. 4A. In some examples, there might not necessarily be communicative connections between every possible pair of modules. Further, while the modules of FIG. 4A are referred to as “software modules,” any one more of them, or any one ore more modules of a different architecture, could be implemented using a combination of hardware, software, and/or firmware.

The example architectural view of UAV 200 is depicted as including flight sensor device(s) 412 and flight control device(s) 414. In the context of FIG. 4A, these are taken to generically represent any one or more sensor devices and/or any one more flight control devices, respectively. For example, sensor devices may include still and/or video camera devices, gyroscopes, altimeters, and/or wind-speed detectors. Flight control devices may include control-surface actuators, such as rudder and/or flap controllers, and winch system 221 shown in FIG. 2. The example architectural view of UAV 200 also includes flight log data 416 for recording actual flight data from flight logger 402.

The architectural view of UAV 200 is useful for representing components of a UAV system, and for consideration of testing of these components when they are updated and/or newly added. A simplified conceptual description of UAV example operation may be described in terms of architectural view of UAV 200 as follows. Flight sensor device(s) 412 may detect, observe, and/or measure environmental conditions or circumstances, as indicated by the broad arrow pointing to the sensors on the right side of FIG. 4A. Flight sensor device(s) 412 may then output corresponding data to flight sensor processor 406 via device interface(s) 410. Flight sensor processor 406 may process the received sensor data and provide processing results to flight controller 404. In turn, flight controller 404 may use the processing results—for example, as some form of control feedback—to determine one or more control actions to be carried out by device controller 408. Device controller 408 may then issue appropriate commands to flight control device(s) 414, via device interface(s) 410.

Flight logger 402 may record various sensor measurements/observations, as well as system and component statuses, for example, to flight log data 416. For example, flight logger 402 could store, as part of flight log data 416, any inputs to, outputs of, and/or internal states of UAV control system 400. Thus, flight log data 416 may represent actual flight data captured by UAV 200 during an actual flight performed by UAV 200, including sensor data captured by flight sensor device(s) 412, control signals provided to flight control device(s) 414, and/or inputs to, outputs of, and/or internal states of any one of flight logger 402, flight controller 404, flight sensor processor 406, and/or device controller 408, among other possibilities. Flight log data 416 may thus represent the effects on UAV 200 of actual environmental conditions that were present during previous flight(s) performed by UAV 200 (e.g., using data from flight sensor device(s) 412) and/or behavior of UAV 200 during, based on, and/or responsive to the actual environmental conditions (e.g., using control signals provided to flight control device(s) 414).

FIG. 4B largely reproduces FIG. 4A, but provides camera device(s) 432 as a particular example of flight sensor device(s) 412, and computer vision system 426 as a particular example of flight sensor processor 406. In this example, environmental input to camera device(s) 432 may be visual detection, observation, and/or measurement. For example, camera device(s) 432 may be and/or include one or more video cameras. The output of the video camera may then be one or more video frames/images that are input to computer vision system 426 via device interface(s) 410. It should be understood that device interface(s) 410 may be and/or include one or more device-specific interfaces implemented in some combination of hardware, software, and/or firmware, for example.

An example function of computer vision system 426 may be to provide service to and/or act as a component of a navigation subsystem. More specifically to such an example, a UAV may begin and/or complete a flight on a landing pad. The landing pad may also serve as a charging station for charging a UAV's batteries, and may sometimes be referred to as a charging pad. The deployment system 314 shown in FIG. 3 and described above may represent the charging pad. In some examples, multiple charging pads may be clustered in an array or other pattern near a warehouse or other facility at which multiple UAVs begin and/or end flight operations/tasks. In order for a UAV completing a flight to identify for landing a specific charging pad among a cluster of charging pads, a number of markers or “fiducials” may be deployed across the cluster of charging pads. Specific fiducials with unique visual patterns may be associated with individual charging pads, and/or fiducials may be arranged across the cluster of charging pads to form a cluster-wide pattern.

In an example operation, a video camera, such as camera device(s) 432, may capture aerial images of a cluster of charging pads and provide video frame data to computer vision system 426. Computer vision system 426 may then apply a pattern recognition program to the video data and a predetermined map of the cluster of charging pads in order to identify a particular charging pad in the cluster upon which the UAV has been instructed to land. The identification may then be provided to flight controller 404, which may use the identification to control landing operations so that the UAV lands on the identified charging pad. Other example operations and/or services of computer vision system 426 may include image-based navigation (e.g., semantic localization, visual-inertial odometry) and aerial surveys.

From time to time, computer vision system 426 and/or other components of UAV control system 400 may be updated with new or modified software, for example. Updates may add new features and/or capabilities, enhance existing features and/or capabilities, and/or correct problems and/or errant behavior and/or operations. There may be other possible reasons for updates. In order to test updated software for computer vision system 426 and/or other components of UAV control system 400, updated software may first be implemented and executed in a UAV test bed or other testing context or environment. In accordance with example embodiments, a UAV test bed may include a computing system that includes one or more processors and program instructions that include one or more software components under test. In particular, the test bed may be configured to run a UAV control system and/or components thereof in a test mode, such that the performance of the software components may be monitored and/or studied individually as well as within an integrated system. In this way, both component and system performance may be evaluated.

One challenge of performance monitoring using a UAV test bed is producing realistic environmental data (e.g., as would be experienced in actual flight) to be used as system input. One way of doing this involves generating synthetic environments and/or synthetic sensor data that represent synthetic flight conditions. However, some synthetic data might not be sufficiently representative of real operating conditions in real physical environments, and thus might not allow for sufficiently accurate and/or reliable performance testing of software components. Exclusive reliance on synthetic data as input for performance testing may be associated with other shortcomings.

Accordingly, actual flight data recorded from previous flights of one or more UAVs may be used for testing of UAV control system 400 and/or components thereof. Such data may include fight sensor input as observed by flight sensors during previous flights, as well as system status that reflects or represents system behavior—e.g., commands issued to flight control devices, UAV control system state history, etc.—during actual UAV flights. In some examples, these data may have been recorded in flight log data 416. However, some or all of the data may have been recorded in other data storage facilities on the UAVs or at ground operations in the case of data transmitted back to ground stations during flights.

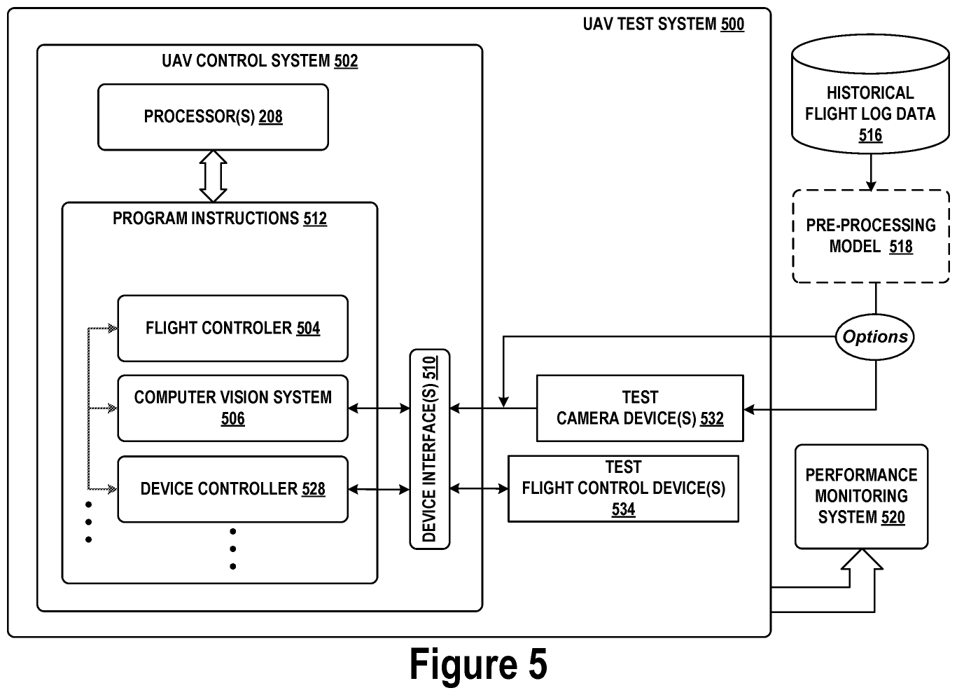

FIG. 5 illustrates an example UAV test system 500 for testing software components of UAV control system 502, such as computer vision system 506. As shown, the UAV test system 500 includes UAV control system 502, test camera device(s) 532, and test flight control device(s) 534. UAV test system 500 may alternatively be referred to as a UAV test bed. UAV control system 502 may include processor(s) 208 and program instructions 512. In the example, the processor(s) 208 may be the same as that implemented on an actual/physical version of UAV 200, though this is not necessarily required for all implementations. Program instructions 512 are shown as including flight controller 504, computer vision system 506, and device controller 528. A flight logger module and flight log data are omitted from program instructions 512 for the sake of brevity in the FIG. 5, but may be part of UAV test system 500. It should be understood that other testing environments could be configured, and the term “UAV test bed” should not be viewed as limiting.

The software component tested by UAV test system 500 may represent any software included in and/or utilized by UAV control system 502. For example, the software component tested by UAV test system 500 may include flight controller 504, computer vision system 506, device controller 528, portion(s) thereof, version(s) thereof, alternative(s) thereof, and/or equivalent(s) thereof, among other possibilities.

UAV test system 500 may also include an interface for monitoring performance of any one or more software components and/or overall system performance of UAV control system 502. The output of monitoring performance of a software component may be referred to herein as an observed performance of the software component, and may include any output(s), internal states, and/or measures of performance of the software component. In the illustrated example, monitoring may be carried out by performance monitoring system 520, depicted at the lower right side of FIG. 5. A broad arrow pointing to performance monitoring system 520 may represent a monitoring interface. Non-limiting example of performance monitoring features and aspects may include monitoring for status and/or error signals and/or conditions, latency/speed measurements, and/or expected and/or unexpected behavior detection (which may represent and/or be part of the observed performance of software component(s)). While performance monitoring system 520 is depicted as being external to UAV test system 500, this need not be the case. In some configurations, performance monitoring system 520 could form part of UAV test system 500.

Any one or more of the depicted modules, and/or possibly others indicated by the vertical ellipses, could be the same as a corresponding module implemented on the UAV 200, and/or any one or more could be specific test bed versions of flight software modules. For example, a test bed version module could be an updated module under test, and/or a current version with an interface for monitoring in a test environment. In this example, UAV test system 500 is taken to be configured for testing computer vision system 506. As such, computer vision system 506 may be an updated, revised, or new software module under test. Flight controller 504 and device controller 528 could be identical to those implemented in an actual UAV 200 (e.g., 404 and 408, respectively), or could be nearly the same, but with particular features or capabilities specific to a test environment, such as monitoring performance.

Similarly, test camera device(s) 532 and/or test flight control device(s) 534 could be actual/physical devices of a UAV 200, and/or emulations of actual/physical devices implemented in hardware, software, firmware, and/or some combination thereof. For example, in some testing configurations, one or more test flight control device(s) 534 could be one or more emulators that output (e.g., display) control signals issued by device controller 528 and received via device interface(s) 510. The emulators may then also generate response signals that would be expected from actual flight control device(s) 414. In some configurations, one or more actual flight control devices 414 may be used.

In the example of testing computer vision system 506, test camera device(s) 532 could similarly represent actual/physical camera device(s) and/or one or more emulated camera devices. For an actual/physical version of camera device 432, the camera could be configured to view a screen on which visual imagery of a flight environment is displayed, and/or hardware lines/buses of the camera could be provided with the visual imagery as detected by another camera during the actual flight. For an emulated camera device, video frames could be supplied as emulated camera output (e.g., the emulator could read the test flight data from a file). Other arrangements are possible as well.

In accordance with example embodiments, input to test camera device(s) 532 may be sourced from actual flight data that has been captured during previous one or more actual flights of one or more UAVs. This is indicated in FIG. 5 by historical flight log data 516, which could represent recorded video data (e.g., frames) captured by camera device(s) 432 during previous actual flights, for example. Thus, historical flight log data 516 may be based on, correspond to, and/or include flight log data 416. As also indicated, pre-processing model 518 may apply some form of preprocessing to historical flight log data 516 before this data is provided as input to test camera device(s) 532. Pre-processing model 518 is depicted with a dashed line to signify that its inclusion and/or the application of preprocessing may be optional. Example forms of preprocessing are described below.

Historical flight log data 516, the output of pre-processing model 518, the output of test camera device(s) 532, and/or device interface(s) 510 may be referred to herein as test flight data. Thus, the test flight data may include and/or be based on historical flight log data 516, which may be processed by one or more components associated with UAV test system 500 (e.g., pre-processing model 518) before being provided as input to one or more software components of UAV control system 502. Thus, the test flight data may be based on actual flight data captured as part of one or more prior flights of one or more UAVs, and may include both modified and unmodified versions of the actual flight data.

In further accordance with example embodiments, historical flight log data-whether preprocessed or not—may be input to UAV test system 500 either (i) through test camera device(s) 532 which then provide the flight log data to device interface(s) 510 or (ii) directly to device interface(s) 510 without going through test camera device(s) 532. In the latter arrangement, historical flight log data 516 may bypass test camera device(s) 532, so long as the data are in a form corresponding to that which would be output from test camera device(s) 532. An oval labeled “Options” in FIG. 5 indicates these two alternative modes of inputting historical flight log data 516 to UAV test system 500. An arrow from “Options” to test camera device(s) 532 represents input to test camera device(s) 532, while another arrow from “Options” that bypasses test camera device(s) 532 represents input to device interface(s) 510.

For input of historical flight log data 516 to test camera device(s) 532, video data captured by camera device(s) 432 during actual UAV flights and recorded in flight logs may be played back on a display device that is viewed by test camera device(s) 532. In this mode of input, test camera device(s) 532 may view presented playback as if they were observing live visual data in real time. The output of test camera device(s) 532 may then be video frames or other forms of image data that are input to computer vision system 506 via device interface(s) 510. For input that bypasses test camera device(s) 532, video frames from historical flight log data 516—possibly preprocessed—may be input directly to device interface(s) 510 for delivery to computer vision system 506.

In either mode, computer vision system 506 may use the input video data (e.g., video frames) to carry out one or more functions, such as charging pad fiducial identification, as described above. Continuing with the example of computer vision system 506 under test in UAV test system 500, performance of computer vision system 506 may be monitored and/or evaluated for correct and/or errant behavior, speed and/or latency, or expected or unexpected interaction with other flight software modules and/or within the overall system. The example of fiducial identification should not be viewed as non-limiting. Rather, it is one of any number of computer vision system 506 functions or operations that may utilize visual data from one or more camera devices, and thus just one of any number of functions or operations that might be tested or exercised in UAV test system 500.

One advantageous aspect of using historical flight log data or other form of actual flight data from one or more previous UAV flights is that it may enable validation of UAV test system 500 itself. For example, historical flight log data 516 may include or record behavior, performance, and/or status of one or more UAVs that collected the data during their flights, in addition to visual data captured by camera device(s) 432 (or environmental data captured by other sensor devices). As such, applying recorded visual data to UAV test system 500 in which all flight software modules are the same as those used in the UAVs that flew missions and collected the flight log data can be expected to yield results that are already known from those previous flights. This mode of testing UAV test system 500 itself may not necessarily test any updated flight software modules, but validation of UAV test system 500 may be a valuable step that ensures UAV test system 500 itself is functioning properly. Such prior validation of UAV test system 500 may therefore enhance confidence in test results when validated UAV test system 500 is subsequently configured and used for testing one or more updated, revised, and/or new software flight modules.

In accordance with example embodiments, historical flight log data 516 of recorded video and/or visual data—and more generally, of any form of recorded flight sensor device data—may be preprocessed in a manner that introduces some form of change and/or distortion corresponding to one or more modifications to the actual environmental conditions that were present when the data was actually captured or acquired by flight sensor device(s) 412 during actual UAV flights. Non-limiting examples of modifications of distortions that may be added and/or applied to the actual flight data include impairments due to spatio-temporal conditions such as weather conditions (e.g., rain, snow, wind, sun, shadows, etc.), increased air traffic in a field of view of a sensor, and/or sensor degradations (e.g., image cropping, image blurring, and/or data loss due to improper sensor function and/or sensor aging, etc.), among other possibilities.

Modified and/or distorted versions of historical flight log data 516 may be referred to herein as augmented flight data. Thus, the augmented flight data may represent a combination of (i) one or more actual environmental conditions that were present in the physical environment during the previous flight and (ii) one or more simulated environmental condition that were not present in the physical environment during the previous flight. Using augmented flight data for testing may allow UAV control system 502 to be tested with realistic flight data that also includes modifications and/or distortions that might be rare and/or difficult to observe across different physical environments. For example, actual flight data from a particular environment that rarely experiences snowfall may be augmented with simulated representations of snowfall, thus allowing UAV control system 502 to be tested under snowy conditions in the particular environment (which might be rare, but for which it may nevertheless be desirable to prepare the UAV).

For example, visual distortion and/or degradation of prerecorded visual flight data may be generated and/or created by simulation of the desired distortion effects. In some examples, simulated degradation may be achieved by intentionally corrupting, modifying, and/or deleting some pixels of the prerecorded video or other image data. The simulated effect could represent and/or simulate impairment of visual data as received by a camera device, and/or simulate corruption/deletion of data output by a camera device, among other possibilities. Thus, computer vision system 506 may be tested for performance and/or behavior under conditions in which it is to function using suboptimal, degraded, and/or errant sensor data.

In some example embodiments, simulated degradation may be achieved by applying an artificial intelligence (AI) and/or machine learning (ML) model to existing historical flight log data 516. The AI and/or ML model (e.g., artificial neural network) may form part of pre-processing model 518. For example, an ML model may be trained to generate imagery corresponding to particular weather effects, such as snow or rain. In particular, such an ML model may modify a given image (e.g., a video frame of a video) to introduce artificially generated visual representations of rain or snow in the image. Similarly, an appropriately trained ML model may artificially generate air traffic imagery that may be introduced in otherwise air traffic-free visual data.

In some implementations, pre-processing model 518 may include a plurality of ML models, where each respective ML model of the plurality of Ml models is configured to add a corresponding type of simulated environmental condition to the actual flight data. For example, the plurality of ML models may include a snow ML model configured to introduce representations of snow into historical flight log data 516, a rain ML mode configured to introduce representations of rain into historical flight log data 516, a lens flare ML mode configured to introduce, into historical flight log data 516, representations of lens flare caused by the sun and/or other bright objects, and so on for any environmental condition to be simulated. Thus, each respective ML model may be configured to receive historical flight log data 516 and/or a portion thereof (e.g., aerial images) as input, and generate output data that includes a representation of the simulated environmental condition added to historical flight log data 516 and/or the portion thereof.

In other implementations, pre-processing model 518 may include an ML model configured to add a plurality of types of simulated environmental condition to the actual flight data, with the specific simulated environmental condition being specified as an input to the ML model. As one example, the simulated environmental condition may be specified by a numerical and/or categorical value corresponding to the environmental condition. As another example, the ML model may be configured to process a textual prompt that specifies the simulated environmental condition to be added to the actual flight data. The ML model may include and/or be based on a multi-modal large language model (LLM) that has been trained to augment sensor data based on textual descriptions of various types of environmental conditions.

The ML model may be trained using training samples, each of which includes (i) a training sensor data without a representation of a particular environmental condition (e.g., an image with no rain), (ii) the training sensor data with the representation of the particular environmental condition (e.g., the same image with rain), and (iii) a representation of the particular environmental condition (e.g., the text “rain,” the text “add rain effects to the input image,” an integer value corresponding to “rain,” etc.). Such training data may be obtained, for example, by flying a given UAV along a training flight path under different environmental conditions. For example, the same training flight path may be flown on each of a clear day (representing and/or approximating ideal/distortion-free conditions), a rainy day, a snowy day, a windy day, and so on, thereby generating, for each respective sensor type of a plurality of sensor types on the UAV, training samples representing the effects of these environmental conditions on the respective sensor type. Thus, the training data may represent the extent to which the outputs of each respective sensor type are affected by different environmental conditions, thus allowing the ML model to learn to introduce the same or similar effects into the actual flight data.

As with distortion and/or degradation introduced using techniques other than AI and/or ML, video and/or visual data modified and/or augmented using AI and or ML techniques may be input to test camera device(s) 532 and then presented as camera device output to computer vision system 506 via device interface(s) 510. ML-modified data may additionally or alternatively be presented directly to device interface(s) 510, bypassing test camera device(s) 532. In this case, preprocessing may include artificially introducing camera device response to the visual data in order to simulate effects of a camera device observing, processing, and/or outputting visual data. Again, computer vision system 506 may then be tested for performance and/or behavior under operating conditions represented by the modified visual data.

In accordance with example embodiments, computer vision system 506 may correspond to an existing, current version of computer vision system 426, and testing may be aimed at evaluating system performance under conditions represented in the distorted or modified visual data. Additionally or alternatively, computer vision system 506 may correspond to a new or updated version of existing software, and testing may be aimed at verifying upgraded features of the software, for example. Other modes of testing are possible as well, and may be used with respect to the testing techniques described herein.

In some embodiments, UAV test system 500 may be implemented in connection with an actual UAV that may be operated (e.g., flown) in a test environment on the basis of the test flight data. For example, the test flight data may be provided as input to one or more actual sensor devices of the UAV during live operation, thus potentially replacing sensor data obtained from sensors of the UAV. Accordingly, the UAV may be operated based on the test flight data and independently of the sensor data obtained from sensors of the UAV. Any one or more components of UAV control system 502 may be subject to performance testing, validation, and/or verification during the live operation. During the live operation, historical flight log data 516 may be used in the same or similar manner as described above, thereby allowing a UAV to be tested in a real physical environment while “pretending” to operate in the environment represented by historical flight log data 516. Such live operations may be carried out, for example, in relatively isolated settings, such as a desert or other remote area, in order to reduce and/or eliminate potential safety issues that might arise from operating the UAV using test flight data that does not accurately represent the real physical environment in which testing is being performed.

Performance monitoring system 520 may be configured to determine a performance metric for the software component tested by UAV test system 500 based on comparing the observed performance of the software component to an expected performance of the software component. The expected performance of the software component may represent a correct, desirable, and/or tolerable behavior of the software component based on and/or in response to the test flight data, and may thus provide a baseline and/or reference relative to which the observed performance of the software component may be evaluated. The expected performance may be represented numerically (e.g., an output of the software component is within a desired range) and/or qualitatively (e.g., the software component did not experience any errors).

As one example, the expected performance of the software component may be based on and/or represent a performance of UAV control system 400 in response to the actual flight data during the previous flight by UAV 200. For example, when UAV 200 successfully and/or satisfactorily performed the previous flight, the behavior of a version of the software component used by UAV 200 in flight may be used to determine the expected performance of the software component being tested using UAV test system 500.

As another example, the expected performance of the software component may be based on and/or represent a performance of a prior version (and/or an alternative version) of the software component in connection with the test flight data. For example, when the prior (and/or alternative) version of the software component has been tested and/or approved to be used in actual flights, the behavior of the prior (and/or alternative) version of the software component with respect to the test flights data may be used to determine the expected performance of the software component being tested.

As a further example, the expected performance of the software component may be based on a software performance test for the software component. For example, the software performance test may be associated with an acceptable range of outputs for the software component when executed as part of the software performance test. Thus, the expected performance may be defined manually by a user and/or programmer of the software performance test. Thus, in some cases, determining the observed performance of the software component may involve executing the software component in connection with the software performance test, where the observed performance may represent one or more outputs of the software performance test.

The performance metric determined by performance monitoring system 520 may indicate the extent to which the observed performance of the software component matches, meets, is similar to, and/or deviates from the expected performance. For example, the performance metric may include a numerical value representing a result of comparing the observed performance to the expected performance. The numerical value may be determined using subtraction, cross-correlation, and/or statistical divergence, among others, and may depend on a data type of the observed and/or expected performance. As another example, the performance metric may include a categorical value representing a result of comparing the observed performance to the expected performance.

Performance monitoring system 520 may be configured to output the performance metric. As one example, the performance monitoring system 520 may cause the performance metric to be transmitted to and/or displayed using a user interface, thereby informing a user of the extent to which the software component performed as expected. As another example, outputting the performance metric may include accepting the software component to be used in live operations (e.g., when the software component operated as expected), rejecting the software component from live operations (e.g., when the software component did not operate as expected), and/or flagging the software component for further evaluation (e.g., when testing of the software component was inconclusive and/or did not produce results with satisfactory confidence). Thus, performance monitoring system 520 may be used to determine, based on the performance metric, whether UAV control system 502 and/or components thereof are fit for operation in physical environments as part of live UAV operations.

While UAV flight software testing described by way of non-limiting example above has been described in the context of computer vision system 506 testing, it should be understood that the techniques described may be straightforwardly extended to testing of other flight software modules and/or subsystems. For example, other flight controllers 504, and/or other components thereof, associated with sensors of a given type other than camera devices may be tested using historical flight log data 516 from sensors of the given type that measured, observed, and/or detected environmental conditions during previous actual flights. As an example, wind speed measurements from wind speed sensors may be used by a navigation module. An updated navigation module may thus be tested by using historical wind speed measurements recorded in historical flight log data 516. Such data may be modified, degraded, and/or distorted, and then used to evaluate performance of a software component (e.g., one that processes and/or relies on the wind speed measurements). As with visual data, wind speed data may be modified by introducing artificial corruption or deletion, and/or by applying an appropriately trained AI and/or ML model.

### VI. Additional Example Operations

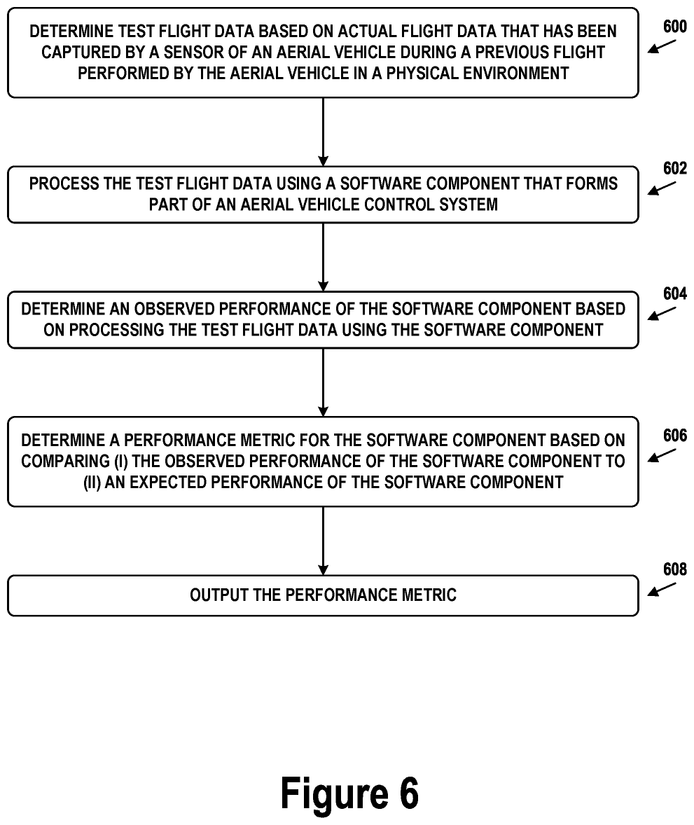

FIG. 6 illustrates a flow chart of operations related to testing flight software with actual flight data. The operations may be carried out by various computing devices, among other possibilities. The embodiments of FIG. 6 may be simplified by the removal of any one or more of the features shown therein. Further, these embodiments may be combined with features, aspects, and/or implementations of any of the previous figures or otherwise described herein.

Block 600 may involve determining test flight data based on actual flight data that has been captured by a sensor of an aerial vehicle during a previous flight performed by the aerial vehicle in a physical environment.

Block 602 may involve processing the test flight data using a software component that forms part of an aerial vehicle control system.

Block 604 may involve determining an observed performance of the software component based on processing the test flight data using the software component.

Block 606 may involve determining a performance metric for the software component based on comparing (i) the observed performance of the software component to (ii) an expected performance of the software component.

Finally, block 608 may involve outputting the performance metric.

In some examples, determining the test flight data may include determining augmented flight data by modifying the actual flight data to represent a simulated environmental condition that was not present in the physical environment during the previous flight.

In some examples, determining the augmented flight data may include processing the actual flight data using a machine learning model configured to modify the actual flight data to represent the simulated environmental condition, and generating the augmented flight data based on processing the actual flight data using the machine learning model.

In some examples, the machine learning model may be configured to modify the actual flight data based on a textual prompt that describes the simulated environmental condition. Processing the actual flight data using the machine learning model may include processing, using the machine learning model, the actual flight data and the textual prompt that describes the simulated environmental condition.

In some examples, determining the augmented flight data may include adding to the actual flight data a distortion expected to be caused by the simulated environmental condition. In some examples, the test flight data may include the actual flight data.

In some examples, the actual flight data may represent effects on the aerial vehicle of actual environmental conditions that were present in the physical environment during the previous flight performed by the aerial vehicle.

In some examples, the actual environmental conditions may represent at least one of: weather conditions, geolocation of the aerial vehicle, or air traffic.

In some examples, determining the test flight data may include providing the actual flight data as input to a physical test sensor that is configured for providing test sensor data to the aerial vehicle control system. Determining the test flight data may also include generating the test sensor data using the physical test sensor based on processing the actual flight data using the physical test sensor. The test flight data may include the test sensor data.

In some examples, the sensor may include a camera, The test sensor may include a test camera. The actual flight data may include video data captured by the camera of the aerial vehicle during the previous flight. Providing the actual flight data as input to the physical test sensor may include displaying the video data using a display configured for viewing by the test camera. Generating the test sensor data may include generating, using the test camera, test video data by capturing the video as displayed using the display.

In some examples, determining the test flight data may include providing the actual flight data as input to a sensor emulator that is configured for providing emulated sensor data to the aerial vehicle control system. Determining the test flight data may also include generating the emulated sensor data using the sensor emulator based on processing the actual flight data using the sensor emulator. The test flight data may include the emulated sensor data.

In some examples, the software component may form part of an updated version of the aerial vehicle control system. Determining the expected performance of the software component may include processing the test flight data using a prior version of the software component that forms part of a prior version of the aerial vehicle control system.

In some examples, the expected performance of the software component may correspond to an actual performance of the aerial vehicle during the previous flight.

In some examples, processing the test flight data may include executing a software performance test of the software component. Determining the observed performance of the software component may include determining an output of the software performance test based on processing the test flight data using the software component. The expected performance of the software component may represent an acceptable range of outputs of the software performance test.

In some examples, processing the test flight data using the software component may include obtaining, from a test sensor of a test aerial vehicle controlled by the aerial vehicle control system, sensor data representing a test environment. The test sensor may be of a same type as the sensor of the aerial vehicle. The sensor data may be replaced with the test flight data. Operation of the test aerial vehicle in the test environment may be controlled using the software component based on the test flight data and independently of the sensor data.

In some examples, outputting the performance metric may include one or more of acceptance of the software component, rejection of the software component, or flagging the software component for further evaluation.

### VII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
a processor; and
a non-transitory computer-readable medium having stored thereon instructions that, when executed by the processor, cause the processor to perform operations comprising:
determining test flight data based on actual flight data that has been captured by a sensor of an aerial vehicle during a previous flight performed by the aerial vehicle in a physical environment;
processing the test flight data using a software component that forms part of an aerial vehicle control system;
determining an observed performance of the software component based on processing the test flight data using the software component;
determining a performance metric for the software component based on comparing (i) the observed performance of the software component to (ii) an expected performance of the software component; and
outputting the performance metric.

2. The system of claim 1, wherein determining the test flight data comprises:
determining augmented flight data by modifying the actual flight data to represent a simulated environmental condition that was not present in the physical environment during the previous flight.

3. The system of claim 2, wherein determining the augmented flight data comprises:
processing the actual flight data using a machine learning model configured to modify the actual flight data to represent the simulated environmental condition; and
generating the augmented flight data based on processing the actual flight data using the machine learning model.

4. The system of claim 3, wherein the machine learning model is configured to modify the actual flight data based on a textual prompt that describes the simulated environmental condition, and wherein processing the actual flight data using the machine learning model comprises:
processing, using the machine learning model, the actual flight data and the textual prompt that describes the simulated environmental condition.

5. The system of claim 2, determining the augmented flight data comprises:
adding to the actual flight data a distortion expected to be caused by the simulated environmental condition.

6. The system of claim 1, wherein the test flight data comprises the actual flight data.

7. The system of claim 1, wherein the actual flight data represents effects on the aerial vehicle of actual environmental conditions that were present in the physical environment during the previous flight performed by the aerial vehicle.

8. The system of claim 7, wherein the actual environmental conditions represent at least one of: weather conditions, geolocation of the aerial vehicle, or air traffic.

9. The system of claim 1, further comprising a physical test sensor configured for providing test sensor data to the aerial vehicle control system, wherein determining the test flight data comprises:
providing the actual flight data as input to the physical test sensor; and
generating the test sensor data using the physical test sensor based on processing the actual flight data using the physical test sensor, wherein the test flight data comprises the test sensor data.

10. The system of claim 9, wherein:
the sensor comprises a camera,
the test sensor comprises a test camera,
the actual flight data comprises video data captured by the camera of the aerial vehicle during the previous flight,
providing the actual flight data as input to the physical test sensor comprises displaying the video data using a display configured for viewing by the test camera, and
generating the test sensor data comprises generating, using the test camera, test video data by capturing the video as displayed using the display.

11. The system of claim 1, further comprising a sensor emulator configured for providing emulated sensor data to the aerial vehicle control system, wherein determining the test flight data comprises:
providing the actual flight data as input to the sensor emulator; and
generating the emulated sensor data using the sensor emulator based on processing the actual flight data using the sensor emulator, wherein the test flight data comprises the emulated sensor data.

12. The system of claim 1, wherein the software component forms part of an updated version of the aerial vehicle control system, and wherein the method further comprises:
determining the expected performance of the software component by processing the test flight data using a prior version of the software component that forms part of a prior version of the aerial vehicle control system.

13. The system of claim 1, wherein the expected performance of the software component corresponds to an actual performance of the aerial vehicle during the previous flight.

14. The system of claim 1, wherein processing the test flight data comprises executing a software performance test of the software component, wherein determining the observed performance of the software component comprises determining an output of the software performance test based on processing the test flight data using the software component, and wherein the expected performance of the software component represents an acceptable range of outputs of the software performance test.

15. The system of claim 1, wherein processing the test flight data using the software component comprises:
obtaining, from a test sensor of a test aerial vehicle controlled by the aerial vehicle control system, sensor data representing a test environment, wherein the test sensor is of a same type as the sensor of the aerial vehicle;
replacing the sensor data with the test flight data; and
controlling operation of the test aerial vehicle in the test environment using the software component based on the test flight data and independently of the sensor data.

16. The system of claim 1, wherein outputting the performance metric comprises one or more of acceptance of the software component, rejection of the software component, or flagging the software component for further evaluation.

17. A computer-implemented method comprising:
determining test flight data based on actual flight data that has been captured by a sensor of an aerial vehicle during a previous flight performed by the aerial vehicle in a physical environment;
processing the test flight data using a software component that forms part of an aerial vehicle control system;
determining an observed performance of the software component based on processing the test flight data using the software component;
determining a performance metric for the software component based on comparing (i) the observed performance of the software component to (ii) an expected performance of the software component; and
outputting the performance metric.

18. The computer-implemented method 17, wherein determining the test flight data comprises:
determining augmented flight data by modifying the actual flight data to represent a simulated environmental condition that was not present in the physical environment during the previous flight.

19. The computer-implemented method 17, wherein determining the augmented flight data comprises:
processing the actual flight data using a machine learning model configured to modify the actual flight data to represent the simulated environmental condition; and
generating the augmented flight data based on processing the actual flight data using the machine learning model.

20. A non-transitory computer-readable medium having stored thereon instructions that, when executed by a computing system, cause the computing system to perform operations comprising:
determining test flight data based on actual flight data that has been captured by a sensor of an aerial vehicle during a previous flight performed by the aerial vehicle in a physical environment;
processing the test flight data using a software component that forms part of an aerial vehicle control system;
determining an observed performance of the software component based on processing the test flight data using the software component;
determining a performance metric for the software component based on comparing (i) the observed performance of the software component to (ii) an expected performance of the software component; and
outputting the performance metric.
